(19) United States
(12) Patent Application Publication
(10) Pub. No.: US 2026/0073905 A1
(43) Pub. Date: Mar. 12, 2026

(54) PITCH CONTROL ALGORITHM

(71) Applicant: Sony Interactive Entertainment Inc., Tokyo (JP)

(72) Inventors: Michael Padilla, San Mateo, CA (US); Murugan Rajenthiran, San Mateo, CA (US); Richard Logan Olabode, San Mateo, CA (US); Lakshmish Kaushik, San Mateo, CA (US)

(21) Appl. No.: 18/828,759

(22) Filed: Sep. 9, 2024

(51) Int. Cl. G10L 13/033

(52) U.S. Cl. CPC G10L 13/0335

(57) ABSTRACT

An algorithm is provided for enabling game developers to create speech from text. The algorithm enables tailoring pitch of intermediate representations of phonemes on a phoneme-by-phoneme basis from the pitch output by a text-to-speech model.

### FIELD

The present application relates generally to local pitch control, and more particularly to phoneme-level pitch control of text-to-speech audio for text-to-speech (TTS) applications including computer games.

### BACKGROUND

Dialog for TTS applications such as computer games can be generated using text-to-speech techniques. As understood herein, models that produce speech from text leave developers the desire at times to fine tune the pitch of the audio that is produced.

### SUMMARY

Accordingly, an apparatus includes at least one processor system configured to receive text and convert the text to plural phonemes, each having a respective phoneme-level pitch value. The processor system further is configured to group the phoneme-level pitch values into N bins, each bin having a same number of phoneme-level pitch values as other bins, and encode each bin with a respective vector such that the phoneme-level pitch values in a respective bin are represented by the respective vector.

In some embodiments the processor system is configured to predict pitch from an input Hₜₑₓₜ, which is identical to decoder input minus any pitch information. In example implementations, the processor system may be configured to send the input Hₜₑₓₜ to a first one-dimensional convolution layer in series with a second one-dimensional convolution layer. The one-dimensional convolutional layers can be concatenated. The processor system may be configured to send output of the one-dimensional convolutional layers to a fully connected layer to produce an output in which, for each of plural tokens, an estimate of an associated token-wise pitch is provided. If desired, unvoiced speech can be represented with an all-0 vector indicating the unvoiced speech has no pitch.

In another aspect, a method includes identifying plural phonemes, each having a respective phoneme-level pitch value. The method also includes grouping the phoneme-level pitch values into N bins, with each bin having a same number of phoneme-level pitch values as other bins. The method includes encoding each bin with a respective vector such that the phoneme-level pitch values in a respective bin are represented by the respective vector.

In another aspect, a device includes computer memory that is not a transitory signal and that includes instructions executable by at least one processor system to predict pitch from an input Hₜₑₓₜ at least in part by sending the input Hₜₑₓₜ to a first one-dimensional convolution layer in series with a second one-dimensional convolution layer and sending output of the one-dimensional convolutional layers to a fully connected layer to produce an output in which, for each of plural tokens, an estimate of an associated token-wise pitch is provided.

In some examples the instructions can be further executable to identify plural phonemes, each having a respective phoneme-level pitch value, group the phoneme-level pitch values into N bins, with each bin having a same number of phoneme-level pitch values as other bins, and encode each bin with a respective vector such that the phoneme-level pitch values in a respective bin are represented by the respective vector.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates example overall logic in example flow chart format consistent with present principles;

FIG. 3 illustrates an example architecture of a first example system for effecting local pitch control consistent with present principles;

FIG. 4 illustrates details of training the system shown in FIG. 3 consistent with present principles;

FIG. 5 illustrates details of using the system shown in FIG. 3 for inferences after training consistent with present principles;

FIG. 6 illustrates details of training an example architecture of a second example system for effecting local pitch control consistent with present principles;

FIG. 7 illustrates details of using the system shown in FIG. 6 for inferences after training consistent with present principles;

FIG. 8 illustrates a histogram related to an example algorithm for local pitch control consistent with present principles;

FIG. 9 illustrates portions of the architecture of an example neural network;

FIG. 10 illustrates an example pitch modification curve consistent with present principles;

FIG. 11 illustrates an example signal representing local pitch control consistent with present principles;

FIG. 12 illustrates an example user interface (UI) of initial (predicted or expected) pitch values output by the TTS model consistent with present principles;

FIG. 13 illustrates another example pitch modification curve consistent with present principles;

FIG. 14 illustrates an example user input element configured as sliders to effect local pitch control consistent with present principles;

FIG. 15 illustrates an alternative example user input element to effect local pitch control consistent with present principles;

FIG. 16 illustrates an example UI of pitch values adjusted after initially being output by the TTS model consistent with present principles; and

FIGS. 17-20 illustrate respective pitch curves after local pitch adjustment consistent with present principles.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

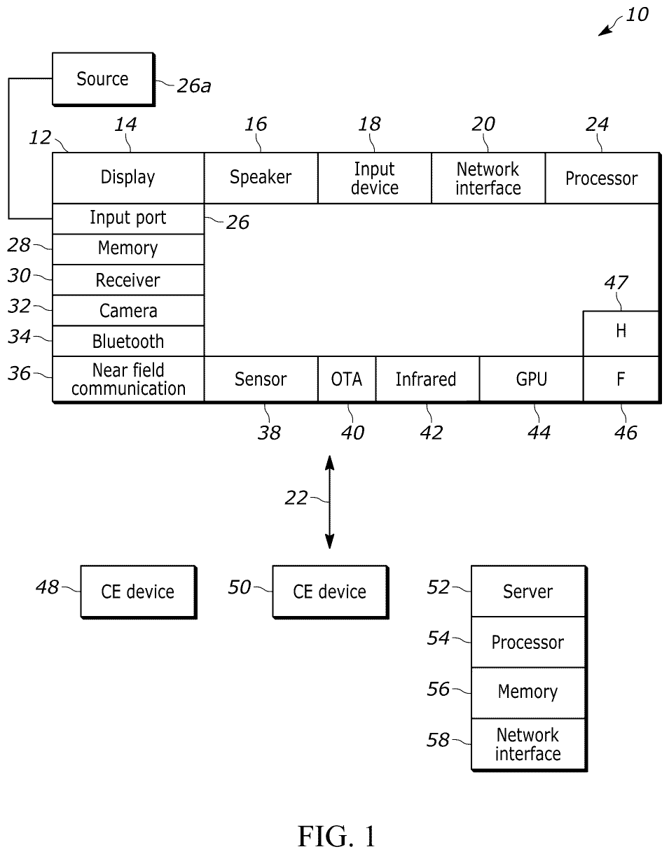

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

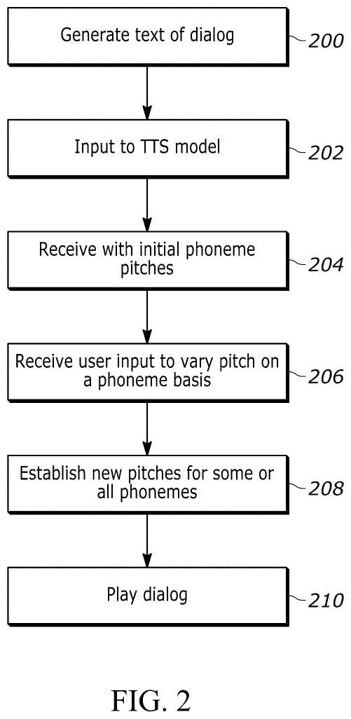

Refer now to FIG. 2 for an understanding of local pitch control, which affords, in addition to text-to-speech (TTS) systems that enable specifying emotion and projection for speech rendered from text, phoneme-level pitch control. This allows a much more refined control of pitch-related nuances, which imply different mood and semantic effects. It is to be understood that phoneme level pitch control may be effected in accordance with present principles without use of emotion and projection.

Commencing at state 200 in FIG. 2, text is generated, e.g., by a computer game developer, that represents dialog of a character in the game or other dialog. Moving to state 202, the text is input to a TTS model implemented using machine learning (ML) techniques. At state 204 the TTS model receives results of initial model computations and computes initial phoneme pitches, some or all of which have initial (or “predicted”) pitches. By “pitch” generally is meant the degree of highness or lowness of a tone.

Moving to state 206, user/developer input is received to vary one or more of the initial (or “predicted”) phoneme pitches on a phoneme-by-phoneme basis at state 208. By “phoneme-by-phoneme basis” is meant the ability to control pitches of individual phonemes independently of the pitches of other phonemes in the speech, it being understood that a developer also has the ability to vary the pitches of a group of phonemes together. As discussed further below, the input at state 206 may be by means of a graphical user interface in which the user draws a pitch modification curve, to control the pitch of each voiced phoneme of the rendered speech to be high or low as desired. Alternate input elements for this purpose also are divulged herein. The dialog is then produced and if desired played at state 210 with phoneme pitches having their initial (or “predicted”) values or having their new values as dictated by the input received at state 206.

Note that the pitch is modified before the audio is actually generated in the final stage. Up to the final stage, where the audio is actually generated, “intermediate representations” are used and modified appropriately to affect the pitches that will be generated when the final audio is created.

In present examples, two types of TTS models may be used, namely, so-called “Tacotron 2” and “VITS”. Present examples add to these frameworks an internal computation of the best predicted pitch values for each voiced phoneme (via a “pitch predictor”) which are used if no user pitch modification is desired, and a graphical UI that allows the user to vary the pitches. From the input, multiplicative weights are extracted for each voiced phoneme that modify the output of the pitch predictor to produce the user's target pitch values for each voiced phoneme. Encoded pitch targets and if desired an encoded emotion target are inserted into the decoding mechanism.

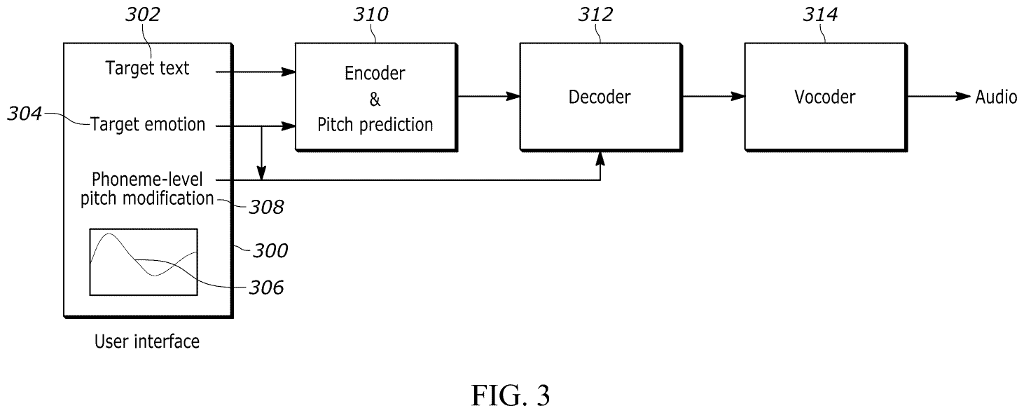

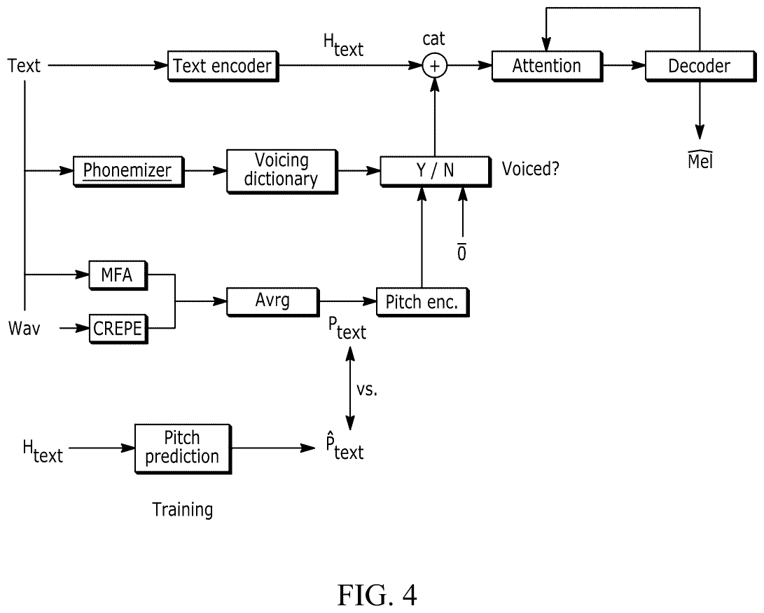

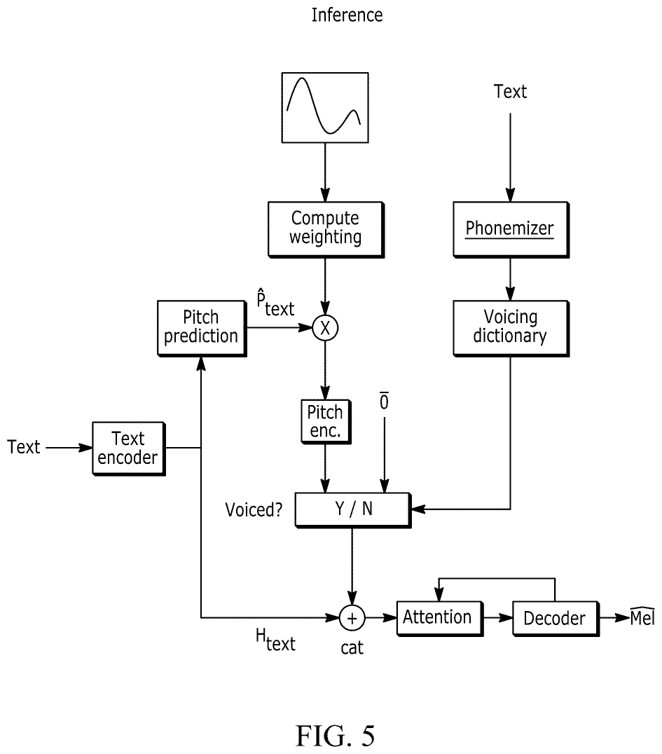

FIG. 3 illustrates a high level diagram of an example that uses the Tacotron-2 system and FIGS. 4 and 5 provide further details of this example. FIG. 3 illustrates that this example includes a serial concatenation of four sub-modules. A UI 300 is provided for a user to enter a target text phrase indicated at 302, specify the phrase-level target emotion as indicated at 304, and via a graphical element 306 draw a curve indicating the phoneme-level pitch modification desired, indicated at 308.

This input is sent to an encoder and pitch prediction model 310. The model 310 converts the target text to a corresponding latent representation and from the target text and, if desired, target emotion, produces phoneme-level initial pitch values (pre-modification/default).

The output of the encoder and pitch prediction model 310 is sent to a decoder 312, which also receives the user's input representing the desired pitch modifications. The decoder 312 converts the text latent representation, target emotion latent representation, and latent representation for the target phoneme-level pitch values after modifying the pitch predictor output by the desired pitch modifications to produce audio, and in a specific embodiment to produce a Mel-spectral representation of the resulting rendered speech file. This is sent to a vocoder 314 which translates the Mel-spectral representation to a time-domain wav file for playing the audio.

FIG. 4 illustrates details of a training architecture for the Tacotron-2 example and FIG. 5 illustrates details of an inference architecture for the Tacotron-2 example. In FIG. 4, an input text sample is input to a text encoder 400. The output of the text encoder 400, denoted Hₜₑₓₜ in the figure, is a T×D matrix of real numbers that represents the output of the text encoder in which T=the number of input tokens (phonemes, punctuation, white space) and D=the size of the representation (i.e. embedding vector) of each such input token.

As used herein, “token” and “phoneme” are different, but related. When the user puts in raw text, e.g., “Hello, how are you? ” the text is first converted to “input tokens”, which is the raw text re-interpreted in terms of underlying phonemes. The input tokens, not the raw text, is input to the processing modules. For the example above, the corresponding input token sequence might be “|HH|AH|L|OW|,|_|HH|AW|_|AA|R|_|Y|UW|?|” which has each of the fifteen tokens bracketed by “|” symbols, with spaces and the “,” and “?” punctuation preserved. This is the representation that is given to the model. Note that phonemes are part of the input token sequence (i.e. the words themselves), but that the latter includes more.

The input text sample also is sent to a phonemizer 402 to divide the text into phonemes and send the phonemes to a voicing dictionary 404. In an example, the phonemizer 402 may be implemented as a neural network module that converts speech transcription into speech tokens (phonemes). The voicing dictionary 404 is a mapping between phoneme representation (arpabet, IPA, etc . . . ) and voiced status. From a physical point of view, voiced phonemes are sounds produced from vocal cord vibration, which correlates to phonemes that have an inherent fundamental frequency or pitch. Unvoiced phonemes do not have an inherent pitch.

The text also is sent to a forced alignment tool 406 such as but not limited to a Montreal Forced Aligner (MFA) that produces time-aligned phonetic representation from speech transcriptions. Audio is input to a CNN-based neural network model 408 that estimates frame-level pitch values for input audio. The outputs of the tool 406 and model 408 are averaged at 510 and the average is sent to a pitch encoder 412. The output Hₜₑₓₜ from the text encoder 400 is input to a pitch prediction module 414. The pitch prediction module 414 may be implemented by a neural network module that estimates the pitch value for each voiced phoneme based on learnings across the training dataset to produce predicted text 415 for comparison to the output of the average state 410 for input to the pitch encoder 412. The predicted text 415 represents the processing applied to Hₜₑₓₜ and is a vector of real values of length T, which is the same T as above ( #of tokens). The comparison may be by upsampling latent representation to align with predicted duration. The pitch encoder 412 may be a neural network module that converts pitch values into an internal latent representation (embedding) to be used for other components in the neural network.

The output of the pitch encoder 412 is sent to a decision block 416, which also receives the output of the voicing dictionary 404, to determine whether the sample was voiced or not, e.g., an example of a sample that would not be voiced would be just the letter “t” as in the word “taco”. There is no pitch associated with this letter. If the sample is not voiced, an all-zero vector is concatenated (whereas with a voiced phoneme, the output of the pitch encoder is used). All-zero vectors may be used for any token that does not have an associated pitch, i.e., any token that's not a voiced phoneme.

If the sample is voiced, the output of the pitch encoder 412 is concatenated at 418 with the output Hₜₑₓₜ of the text encoder 400. The concatenation may be a combination of embeddings through addition or through stacking embeddings. The result of the concatenation is one or more attention vectors 420 which are sent to a decoder 422.

FIG. 5 illustrates the inference architecture of the elements of FIG. 4. In FIG. 5, a curve 500 that is drawn in the user interface is sent to a compute block 502, which implements a mapping algorithm between user-drawn pixel values and text-aligned scaling values for pitch. From the curve 500, modification weights are computed, which are then multiplied against the outputs of the pitch prediction, to form the actual post-modification pitch targets.

The output of the compute block 502 is combined at state 504 by element-wise multiplication with the output of the now-trained pitch prediction 414, which receives the output of the text encoder 400 as shown.

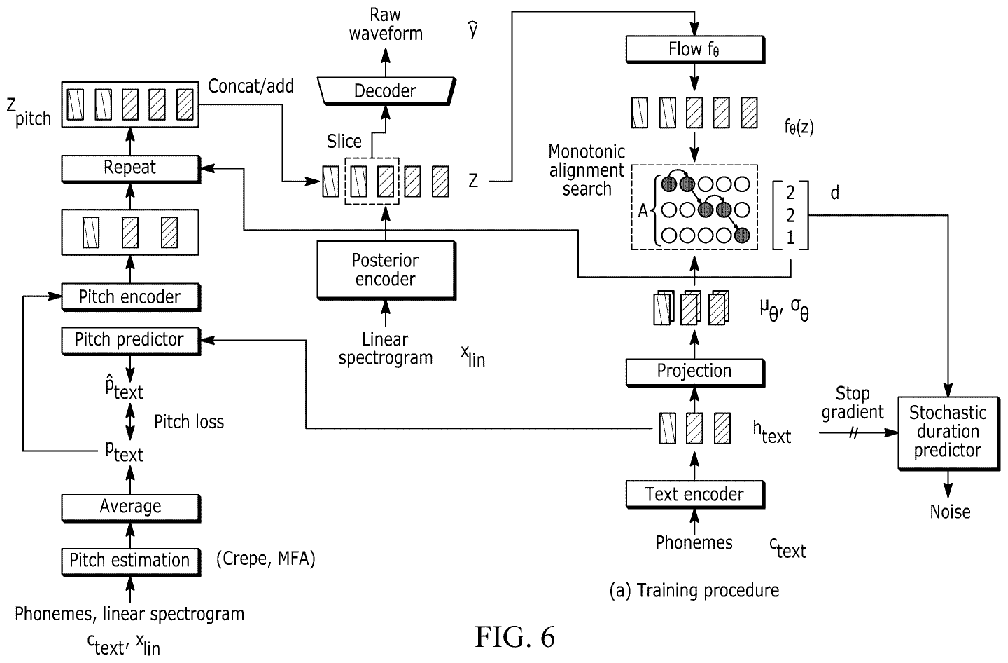

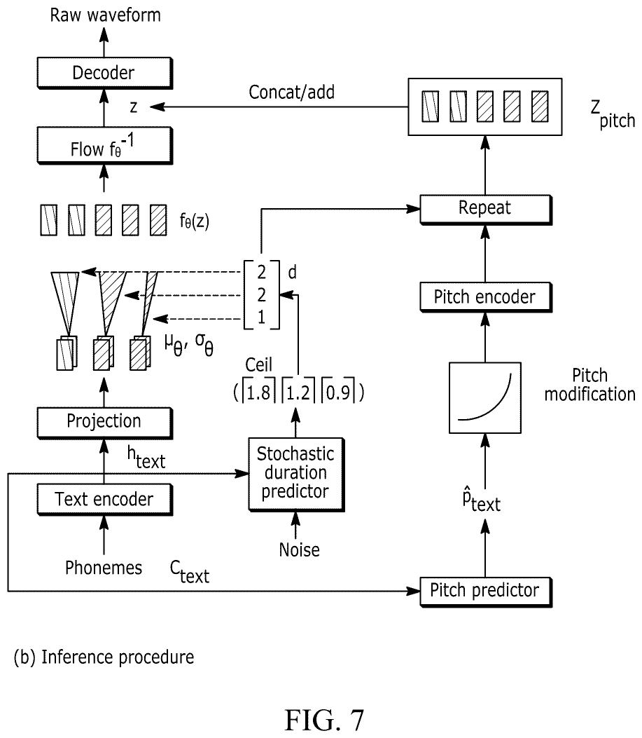

FIGS. 6 and 7 respectively illustrate details of training and inference architectures of a VITS-based example, which is similar to the Tacotron2-based system with regard to the UI and pitch curve, pitch prediction, and pitch encoding but that uses a different module architecture and a different insertion of the pitch and emotion representations into the baseline framework compared to the tactotron-2 example. Note that emotion control may be effected by adding emotion embedding to the pitch embedding before the decoder, in which case an additional loss term can be incorporated to establish emotion versus pitch embedding orthogonality.

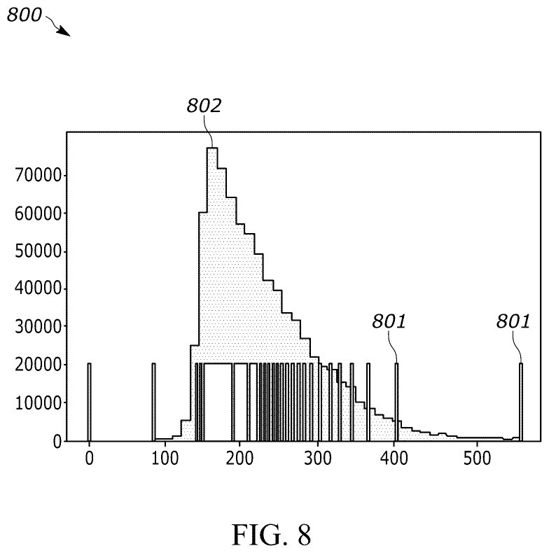

Now refer to FIG. 8, which illustrates an algorithm that may be used in conjunction with pitch encoding with either of the example TTS models discussed above. A histogram 800 is shown of voiced phoneme-level pitch values. In the histogram 800, the x-axis represents pitch from lower to higher and the y-axis represents the number of samples.

FIG. 8 illustrates that the phoneme-level pitch values in the training data are divided into bins, each of which has the same number of samples. Each bin is encoded with either a learned “one-hot” embedding, or with a precomputed positional embedding. Note that unvoiced speech (such as a whisper or a tongue click) may be represented with an all-0 vector (having no pitch).

The lines 801 illustrate boundaries of the bins that are used to group unquantized (raw) pitch values into groups. Assume an example having sixty bins and thus sixty-one boundary lines 801. All pitch is represented as being in one of those bins. It may now be appreciated that an infinite number of raw/unquantized pitch values can be represented in a small (e.g., sixty) number of representations. A different encoding (embedding vector) is used for each of the bins, which is how pitch is represented.

The bars 802 are the histogram values, representing the number of times a given pitch value occurs in the training data. When the histogram is plotted, it does so by binning the data, but that is only in order to draw a plot.

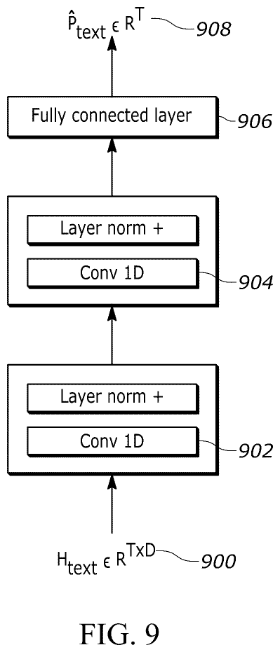

While FIG. 8 represents an example algorithm for pitch encoding, FIG. 9 represents an example algorithm for pitch prediction for both the Tactoron-2 and VITS examples above. The input 900 (Hₜₑₓₜ), which can be identical to the input to the decoder minus any pitch information, i.e., text, word, and emotion embeddings, is sent to a first one-dimensional convolution layer 902 and then to a second one-dimensional convolution layer 904 in series with the first layer the two 1-D layers are thus concatenated). Data flow from the second one-dimensional convolution layer 904 to a fully connected layer 906 to produce an output 908 (the same or equivalent to the element 415 in FIG. 4) in which, for each token, an estimate of the associated token-wise pitch is provided. Note that this architecture applies only to voiced phonemes.

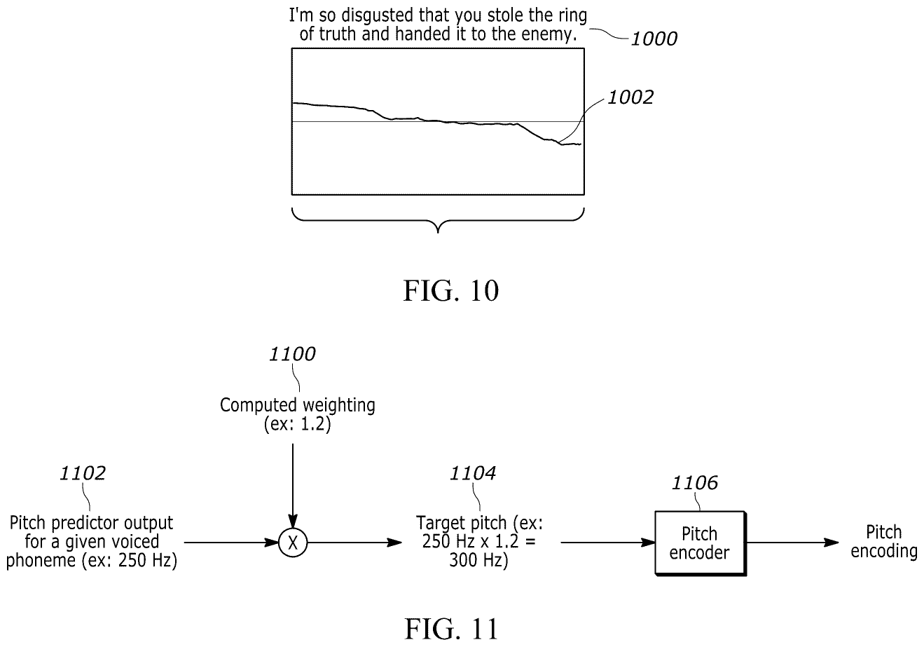

FIG. 10 illustrates a first input element to vary pitch on a phoneme-by-phoneme basis in which the user first enters text 1000 to synthesize. The input element of FIG. 10 is a pitch modification curve 1002 drawn by the user over all (or part) of the text indicating how, relative to the default values provided by the pitch predictor, the pitch should be modified. The curve 1002 defines a weighting on a phoneme-by-phoneme basis in which if pitch is to be increased the weighting is greater than one and if pitch is to be decreased the weighting is less than one. If no change is desired from the initial (predicted) pitch the weighting defined by the curve is equal to one. In an example, the pitch weighting range is [0.5, 1.5].

In FIG. 10, the horizontal axis is partitioned into segments proportionally to the duration of each phoneme. Cross-referencing FIGS. 10 and 11, for voiced phonemes the drawn curve is averaged to get the average weight 1100 (FIG. 11) for that phoneme. That weight is then applied to the output 1102 of the pitch predictor to generate the final target pitch 1104, which is then encoded by the encoder 1106 and provided to the decoder.

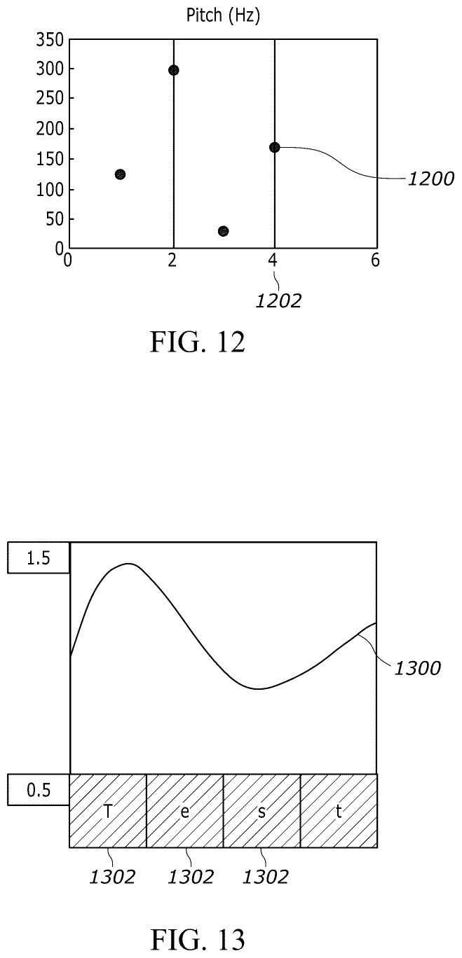

FIG. 12 illustrates that pitch prediction indicators 1200 may be presented on a display. In FIG. 12, the y-axis represents pitch in Hertz and the x-axis represents the sequence of phonemes. This aids the user in making the pitch adjustments. Note that the pitch values 1200 are aligned with the voiced input text phonemes 1202.

FIG. 13 illustrates another example pitch modification curve 1300 drawn by a user to modify pitch on a phoneme-by-phoneme basis. The pitch modification curve 1300 is internally divided into phonemes 1302 and values of the pitch modification curve 1300 are quantized. As illustrated in FIG. 11 discussed above, the quantized values of the pitch modification curve 1300 are multiplied with the predicted pitch values from the TTS model to produce the user-desired pitch values for the audio derived from the input text.

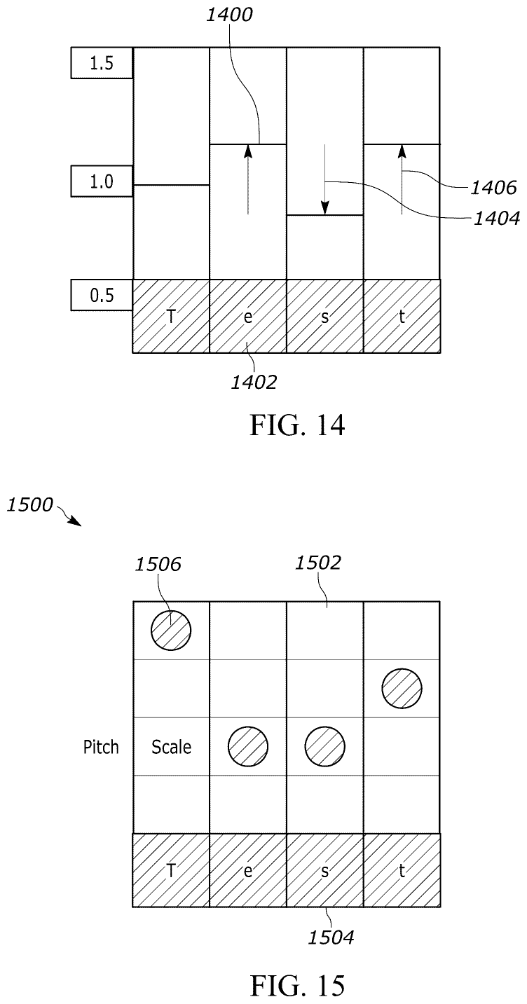

Another example input element is illustrated in FIG. 14, in which, instead of a pitch modification curve, sliders 1400 are movable by a user up and down for each phoneme 1402 to raise (or lower) the initial predicted pitch. Slider movement is indicated by the arrows 1404, 1406, and the height of a slider above the x-axis defines the value of the slider. As was the case with the quantized pitch modification curve vales of FIG. 13, the values of the sliders in FIG. 14 are multiplied with the predicted pitch values to produce the desired modified pitches for the respective phonemes.

A further alternative input element is illustrated in FIG. 15, in which a grid 1500 is divided into cells 1502. Each phoneme 1504 is associated with a column of cells 1502, and a user can select as indicated at 1506 a cell 1502 in the column of a phoneme to establish the desired pitch for that phoneme, with the cells defining pitch from low to high up the y-axis. As was the case with the quantized pitch modification curve vales of FIG. 13, the values of the selected cells 1502 in FIG. 15 are multiplied with the predicted pitch values to produce the desired modified pitches for the respective phonemes.

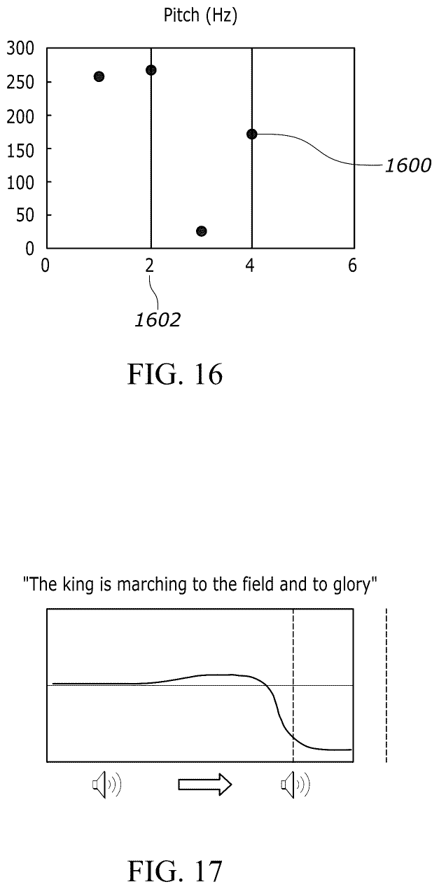

While FIG. 12 illustrates a display of the initial predicted pitch values, FIG. 16 illustrates that the adjusted pitch values 1600 of synthesized audio can be presented on a display to provide feedback to the user on how the pitch was adjusted by the user after synthesis. The pitch values 1600 in FIG. 16 are aligned with the respective voiced input text phonemes 1602 a shown. For purposes of FIG. 16 the pitch values may be estimated using a ML model or audio analysis.

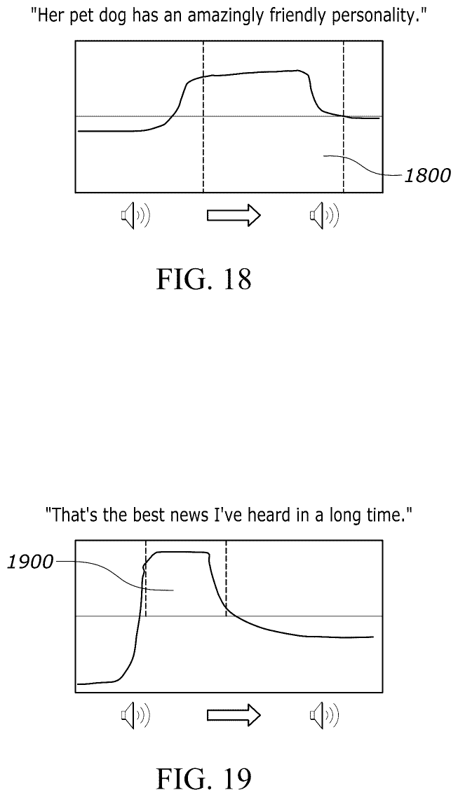

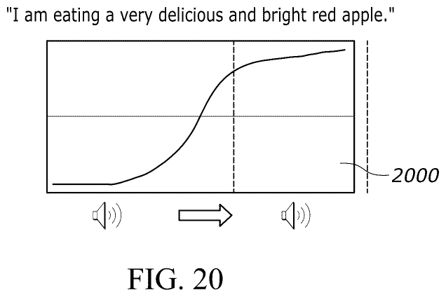

FIGS. 17-20 illustrate the results of phoneme level pitch modification provided for by present techniques for four respective phrases showing segments of the text representing the output audio after pitch adjustment as having had their pitches lowered (segment 1700 in FIG. 17) from the initial predicted pitch or raised (segments 1800, 1900, 2000 in FIGS. 18-20) from the initial predicted pitch.

While the particular embodiments are herein shown and described in detail, it is to be understood that the subject matter which is encompassed by the present invention is limited only by the claims.

What is claimed is:

1. An apparatus comprising:
at least one processor system configured to:
receive text;
convert the text to plural phonemes, each having a respective phoneme-level pitch value;
group the phoneme-level pitch values into N bins, each bin having a same number of phoneme-level pitch values as other bins; and
encode each bin with a respective vector such that the phoneme-level pitch values in a respective bin are represented by the respective vector.

2. The apparatus of claim 1, wherein the processor system is configured to:
predict pitch from an input Hₜₑₓₜ, which is identical to decoder input minus any pitch information.

3. The apparatus of claim 2, wherein the processor system is configured to:
send the input Hₜₑₓₜ to a first one-dimensional convolution layer in series with a second one-dimensional convolution layer.

4. The apparatus of claim 3, wherein the one-dimensional convolutional layers are concatenated.

5. The apparatus of claim 4, wherein the processor system is configured to send output of the one-dimensional convolutional layers to a fully connected layer to produce an output in which, for each of plural tokens, an estimate of an associated token-wise pitch is provided.

6. The apparatus of claim 1, wherein unvoiced speech is represented with an all-0 vector indicating the unvoiced speech has no pitch.

7. A method comprising:
identifying plural phonemes, each having a respective phoneme-level pitch value;
grouping the phoneme-level pitch values into N bins, each bin having a same number of phoneme-level pitch values as other bins; and
encoding each bin with a respective vector such that the phoneme-level pitch values in a respective bin are represented by the respective vector.

8. The method of claim 7, comprising:
predicting pitch from an input Hₜₑₓₜ, which is identical to input at a decoder minus any pitch information.

9. The method of claim 8, comprising:
sending the input Hₜₑₓₜ to a first one-dimensional convolution layer in series with a second one-dimensional convolution layer.

10. The method of claim 9, wherein the one-dimensional convolutional layers are concatenated.

11. The method of claim 10, comprising sending the output of the one-dimensional convolutional layers to a fully connected layer to produce an output in which, for each of plural tokens, an estimate of an associated token-wise pitch is provided.

12. The method of claim 7, wherein unvoiced speech is represented with an all-0 vector indicating the unvoiced speech has no pitch.

13. A device, comprising:
computer memory that is not a transitory signal, the computer memory comprising instructions executable by at least one processor system to:
predict pitch from an input Hₜₑₓₜ at least in part by:
sending the input Hₜₑₓₜ to a first one-dimensional convolution layer in series with a second one-dimensional convolution layer; and
sending output of the one-dimensional convolutional layers to a fully connected layer to produce an output in which, for each of plural tokens, an estimate of an associated token-wise pitch is provided.

14. The device of claim 13, wherein the one-dimensional convolutional layers are concatenated.

15. The device of claim 13, wherein the instructions are executable to:
identify plural phonemes, each having a respective phoneme-level pitch value;
group the phoneme-level pitch values into N bins, each bin having a same number of phoneme-level pitch values as other bins; and
encode each bin with a respective vector such that the phoneme-level pitch values in a respective bin are represented by the respective vector.

16. The device of claim 15, wherein the instructions are executable to:
represent unvoiced speech is represented with an all-0 vector indicating the unvoiced speech has no pitch.
